(19) United States
(12) Patent Application Publication
(10) Pub. No.: US 2002/0107728 A1
(43) Pub. Date: Aug. 8, 2002

(54) Targeted communications based on promotional response

(75) Inventors: Tony A. Bailey, Long Grove, IL (US); Gary M. Katz, Northbrook, IL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Catalina Marketing International, Inc., St. Petersburg, FL (US)

(21) Appl. No.: 09/776,683

(22) Filed: Feb. 6, 2001

(51) Int. Cl. G06F 17/60

(52) U.S. Cl. 705/14

(57) ABSTRACT

A method, system, and computer-readable medium that determine a promotion for a consumer based at least in part upon promotions exercised by the consumer. By examining exercised promotions, promotions likely to be exercised by certain consumers and consumers likely to exercise certain promotions can be identified. This invention can also be performed across the boundaries of product industry, class, and/or type.

### BACKGROUND OF THE INVENTION

1. Field of the Invention

This invention is directed toward effectively targeting promotions. More specifically, this invention is directed toward effectively targeting promotions based upon a historical record of promotion usage.

2. Discussion of the Background

Predictive targeting describes a marketing technique wherein marketing efforts are directed to an individual or group of individuals that have characteristics which indicate the likelihood of a certain behavior, such as a purchase and/or exercising a promotion. The examined characteristics of the individual or group commonly include a historical record of purchases and/or demographic data. By targeting marketing efforts to an individual or group considered to be likely to be interested in a product according to a predictive profile, the expense of marketing can be reduced and even small groups of individuals who are likely to be interested in a product can receive promotions regarding the product on a low cost per capita basis. A more complete description of predictive targeting and marketing is given, e.g., in “The Direct Marketing Handbook,” Edward L. Nash, ed., McGraw-Hill, New York, 1992, the entire contents of which are incorporated herein by reference, and in U.S. Pat. Nos. 6,026,370, 5,974,399, 5,892,827, 5,832,457, 5,612,868, 5,173,851, 4,910,672, 6,014,634, 6,055,573 the entire contents of all of which are incorporated herein by reference.

Despite the fact that demographic and/or historical purchase records provide great advantages in predetermining the behavior of a group and/or individual, these records still remain relatively coarse and the correlation between the known demographic and/or historical purchase parameters and actual consumer behavior remains unsatisfactory low. This low correlation prevents further minimization of the costs associated with marketing, thus wasting financial resources of the practitioners of predictive marketing. As such, there is a constant quest by these practitioners to gain access to more descriptive and/or complete data that is more highly predictive of group and/or individual behavior.

Another difficulty with traditional predictive targeting is the speciation of the demographic and/or historical purchase records along the lines of industry, product type, and/or product class. For example, a historical purchase record that indicates the likelihood that a consumer will purchase an expensive personal care product may hold little value to, e.g., a provider of financial services or a telephone company hoping to recruit new subscribers. This problem is especially germane to potential practitioners of predictive targeting who are promoting products outside the packaged goods industry. Currently, large amounts of historical purchase record data is being collected at supermarkets, due in part to the frequency of purchases at the supermarket and the widespread use of customer loyalty cards at supermarkets. However, simple historical purchase record data is only of minimal value to potential practitioners of predictive targeting who are promoting products that are not commonly, or only occasionally, sold at supermarkets. Example of such potential practitioners of predictive targeting include, e.g., service providers (e.g., telephone services, legal services, financial and/or banking services), durable goods retailers and manufacturers (e.g., automobile dealerships, appliance retailers), and a whole host of other retailers such as clothing retailers and restaurants. Moreover, in many consumer product categories outside the packaged goods industry, the occurrence of a purchase event is too seldom for a practitioner of predictive targeting to obtain meaningful purchase history records. For example, an individual may only purchase a washing machine every seven years or so, and thus a generation's worth of purchase records may be necessary to determine if, e.g., a consumer is loyal to a particular washing machine brand name. Moreover, even if such data existed, the likelihood that a consumer's priorities remained unchanged over such long periods is diminishingly small.

### SUMMARY OF THE INVENTION

Accordingly, one object of this invention is to provide a novel method, system, and computer-readable medium for providing parameters that can be used to more effectively predict consumer behavior based on a historical record of consumer behavior.

Another object of this invention is to provide a novel method, system, and computer-readable medium for that provides parameters that can be used to predict consumer behavior across industry boundaries, product type boundaries, and/or product class boundaries.

A further object of this invention is to provide a novel method, system, and computer-readable medium for that provides parameters that can be used to predict consumer behavior based upon data collected with minimal effort by the consumer.

Yet another object of this invention is to provide a novel method, system, and computer-readable medium for that provides parameters that can be used to predict consumer behavior across industry boundaries and/or product type or class boundaries, when these parameters are derived from consumer behavior when making packaged goods purchases.

A still further object of this invention is to provide a novel method, system, and computer-readable medium for that provides parameters that can be used to predict consumer behavior across industry boundaries and/or product type or class boundaries, when these parameters are derived from consumer purchase behavior in a supermarket.

These and other objects of the invention are realized by providing a novel method, system, and computer-readable medium that use a historical record of the exercise of promotions to provide one or more promotions. In one embodiment, the historical record of the exercise of promotions is the historical record of the value of the exercises promotions. In an further embodiment, the value of the exercised promotion is a real (e.g., dollar) value of the exercised promotion. In another embodiment, the value of the exercised promotion is a relative (e.g., percent of total cost) value of the exercised promotion. In another embodiment, the historical record of the exercise of promotions is the historical record of the frequency of the exercise of promotions. In one embodiment, the exercised promotions are in one industry, and the provided promotions are in another industry. In another embodiment, the exercised promotions are in one product class or type, and the provided promotions are in another product class or type. In one embodiment, the exercised promotions are in the packaged goods industry. In another embodiment, the exercised promotions are exercised at a supermarket.

As used herein, the term “promotion” refers to any offer, advertisement, flier, newsletter, incentive, coupon, commercial, recipe, and/or communication for promoting one or more goods and/or services.

As used herein, to “exercise” a promotion refers to any redemption, consumption, employment, application, availment, weilding, clicking, exploitation, viewing, use, hearing, and/or reading of a promotion.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 illustrates an exemplary network structure for targeting promotions based upon a historical record of promotion usage;

FIG. 2 illustrates a second exemplary network structure for targeting promotions based upon a historical record of promotion usage;

FIG. 3a and 3b illustrate two exemplary data records for storing promotion identification data and consumer identification data;

FIGS. 4a and 4b illustrate two exemplary data records for storing exercised promotion data and consumer demographic data;

FIGS. 5a and 5b illustrate two exemplary data records for consumer purchase history data and analysis tool data;

FIG. 6 is an exemplary data table for storing exercised promotion records according to the date when a promotion was exercised.

FIG. 7 is a flow chart that illustrates an exemplary promotion-driven method for performing the present invention;

FIG. 8 is a flow chart that illustrates an exemplary consumer-driven method for performing the present invention;

FIG. 9 illustrates consumer-driven method for providing targeted promotions based upon exercised promotions that is driven by the instantaneous presence of a consumer at a particular location;

FIG. 10 illustrates a promotion-driven method for performing the invention;

FIG. 11 illustrates a method for performing the invention; and

FIG. 12 illustrates an exemplary computer system that can form several different units in an embodiment of the present invention.

### DETAILED DESCRIPTION OF THE PREFERRED EMBODIMENTS

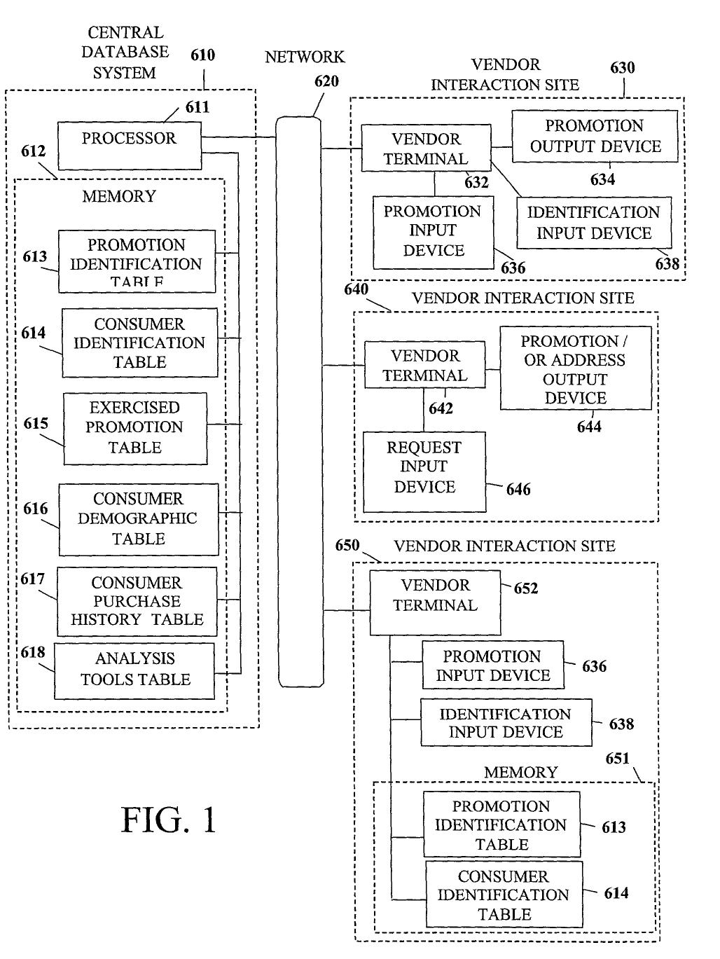

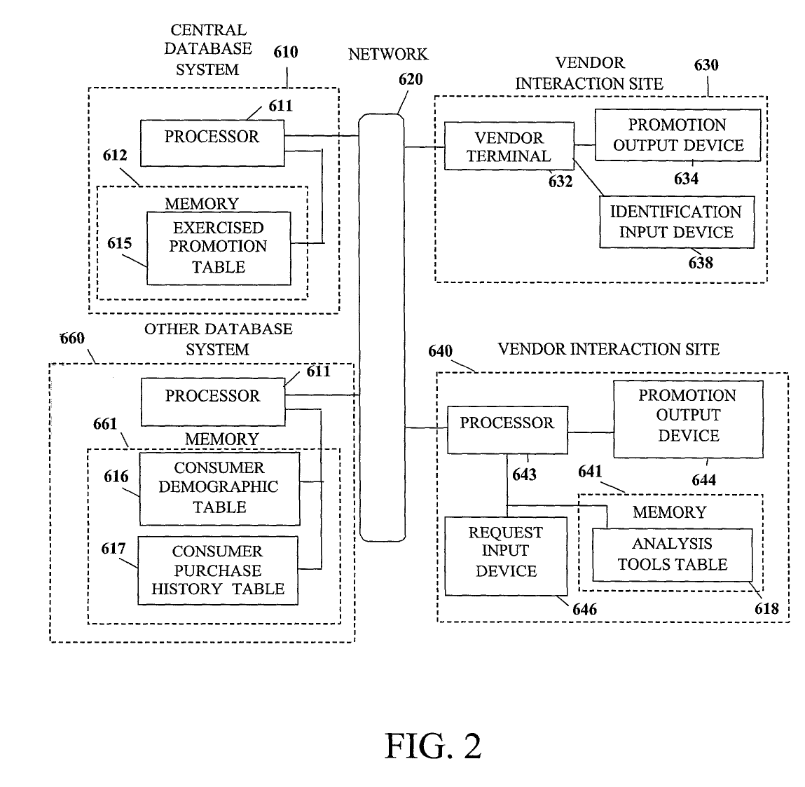

Referring now to the drawings, wherein like reference numerals designate identical or corresponding parts throughout the several views, and more particularly to FIGS. 1 and 2 thereof, which illustrate exemplary network structures for targeting promotions based upon a historical record of promotion usage. These network structures will include at least one vendor interaction site 630, 640, 650, 670, and/or 680 that is connected by way of a network 620 to a central database system 610. In alternate embodiments, network 620 can be dispensed with in whole or in part, and the one or more vendor interaction site 630, 640, 650, 670, and/or 680 can include the data and functionality herein attributed to the central database system 610. This is explicitly illustrated in vendor interaction sites 650 of FIGS. 1 and 2 which contain a promotion identification table 613 and consumer identification table 614 and vendor interaction sites 680 of FIG. 2 which contains an analysis tool table 618, also found in central database system 610 of FIG. 1. Thus, the network 620 can be implemented either as a communications or telecommunications network, or as an electrical lead, wire, or bus within a computer. As illustrated in FIG. 2, the central database system 610 of FIG. 1 can be divided into a plurality of database systems, such as central database system 610 and 3^{rd} party database system 660 of FIG. 2, each directed to a subset of the data and functionality ascribed to the central database system 610 illustrated in FIG. 1. Furthermore, some embodiments of the network structure may include a vendor interaction site 650 which can combine some or all of the structures and/or functionality ascribed to central database system 610 with a vendor interaction site 630. As illustrated in FIGS. 1 and 2, the vendor interaction site 650 is connected to the central database system by way of network 620. This is not necessarily the case, and the vendor interaction site 640 and the central database system 610 can be combined into one or more physically discrete units that may or may not be connected to a network.

The processor 611 of central database system 610 is used for coding and decoding data transmitted over network 620, controlling reading and writing of data in tables 613, 614, 615, 616, 617, and 618, and analyzing the data in tables 613, 614, 615, 616, 617, and 618. The processor 611 (and processors 642 and 682) can be any processor configured for high volume data transmission and performing a significant number of mathematical calculations in processing communications(possibly as a webserver), database searches, and computational algorithms. A conventional personal computer or workstation with sufficient memory and processing capability may be configured to act as processor 611. A PENTIUM III Microprocessor such as the 1 GHz PENTIUM III for the SC 242 manufactured by Intel Inc., a Motorola 500 MHZ POWERPC G4 processor, and the Advanced Micro Devices 1 GHz AMD ATHLON processor may all be used as the processor 611. The tables 613, 614, 615, 616, 617, and 618 may reside or be stored on any suitable processor-accessible data medium, including but not limited to any type of disk including floppy disks, optical disks, CD-Rom, magneto-optical disks, ROMs, RAMs, EPROMs, EEPROMs, flash memory, magnetic or optical cards, or any type of media suitable for storing electronic data.

The network 620 may be a local area network, a wide area network (such as the Internet), a virtual private network, and/or a connection via a public switched telephone network. In an exemplary embodiment, the network 620 includes a number of connection modalities, including a cable-modem connection, a DSL connection, a dial-up modem connection, and/or other suitable connection mechanisms.

The first vendor interaction site 630 includes a vendor terminal 632 that would be located at, e.g., the check-out counter of a store, a vending machine, a central location shared by several stores, a mobile kiosk at a central location in a trade show, flea market, or street fair, an airline ticket counter, an entrance of a public accomodation such as a ballpark, nightclub, casino, or movie theater, a restaurant, a telephone where sales orders are placed, or even an individual's home computer in the case of Internet transactions. The vendor terminal 632 can include a processor similar to processor 611, but in an exemplary embodiment it is simply dedicated to the reception and transmission of data over network 620 and the coding and decoding of data received from promotion input device 638, ID input device 638, and output to promotion output device 630b.

Vendor interaction site 630 is designed to be operated by the vendor and/or the potential customer. When the vendor interaction site 630 is placed at a position where the vendor can control the operation of the device (e.g., check-out counter, entrance to club or theater, airline ticket counter), the vendor is the party primarily responsible for the maintainence of the site. However, in certain transactions, such as in the case of Internet transactions, the vendor interaction site 630 may be physically removed from the vendor and owned/operated by, e.g., a consumer. Thus, an individual consumer's home personal computer can form a vendor interaction site 630, even though the vendor is not responsible for the site. Some locations of the vendor interaction site 630, such as at a mobile kiosk at a flea market or trade show, may include having a 3^{rd} party be responsible for the vendor interaction site 630.

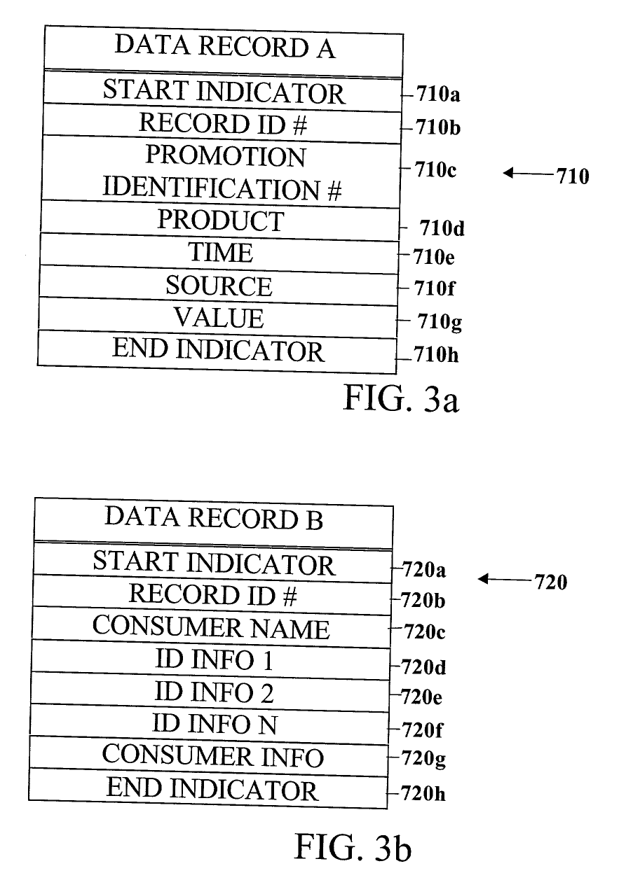

In some embodiments, vendor interaction site 630 can include a promotion input device 636 such as a keyboard, touch screen, computer mouse, bar code reader, magnetic reader (including strip, disk, and tape reader), smart card reader, pressure sensor, motion detector, electromagnetic receiver, voltmeter, heat sensor, and other transducer capable of receiving promotion identification information. One common example is a bar code reader that transduces barcodes on coupons at a supermarket check-out counter. The promotion identification information will allow the vendor and/or maintainer of the central database system 610 to identify information about the promotion presented to the promotion input device 636 at the vendor terminal 630. This information can be the compared with previously stored information located in promotion identification table 613 so that the promotion presented to the promotion input device 636 may be identified, recorded, and/or analyzed. Alternatively, as mentioned above, if the promotion identification table 613 is located at the vendor interaction site (as explicitly illustrated in vendor interaction site 630), the promotion identification information need not be transmitted over network 620 to central database system 610. An exemplary data record that could be found in promotion identification table 613 is illustrated as Data Record A 710 of FIG. 3a. Once the promotion presented to the promotion input device 636, some or all of the information found in the promotion identification table 613 can be relayed to the vendor interaction site. This may include, e.g., a product identification number that can be compared to the products presented at the vendor interaction site 630, or a confirmation of the value of the promotion for use by the vendor interaction site 630 when computing an consumer's bill.

The exemplary vendor interaction sites 630 also includes an identification input device 638 that receives identification information from a consumer. In the exemplary vendor interaction site 630, the received identification information is forwarded to the central database system 610 where processor 611 compares it with previously stored information found in consumer identification table 614 to provide a confirmed identification of the consumer. Identification input device 638 can be any of a number of devices that receive and/or transduce identifying information regarding a consumer. Examples of embodiments of identification input device 638 that transduce identifying information include keyboards, touch screens, computer mouses, bar code readers, magnetic readers (including strip, disk, and tape readers), smart card readers, pressure sensors, motion detectors, electromagnetic receivers, voltmeters, heat sensors, voice transduction devices (e.g., microphones), digital cameras, fingerprint readers, iris recognition devices, genetic identification devices, and other transducers capable of transducing identification information regarding an individual and transferring this information to a digital processor. Examples of embodiments of identification input device 638 that receive identifying information without performing a transduction of a physical parameter include processors configured to receive digitized signals, images, sounds, patterns, and/or other information and analog-to-digital converters configured to convert analog signals, images, sounds, patterns, and/or other information into a digital format. Thus, the identification input device 638 of the vendor interaction site 630 need not conduct the actual transduction of the identification information, but rather identification input device 638 must simply be capable of receiving identification input from a consumer. One particular example of an identification input device 638 is a preferred customer card reader at a checkout counter in a supermarket.

Since the vendor interaction site 630 (including the identification input device 638) can be operated by a consumer and/or third party, the identification information can be a code or password provided by, e.g., a vendor for use by a particular customer. This can include, for example, a cookie placed on the consumer's home computer. Regardless of the nature of the identifying information, it is used to “identify” the consumer.

Regardless of the nature of identification input device 638, once identification data is transduced and/or received, it can be transferred from vendor terminal 632 to processor 611 of central database system 610. Naturally, this can be done by way of a network 620, or alternatively a processor similar to processor 611 can be part of vendor interaction site 630 (as shown in vendor interaction site 650). Regardless of the location of processor 611, the processor 611 can compare the received identification information to previously stored identification information found in consumer identification table 614 to determine the identity of the consumer. An exemplary data record that could be found in identification table 614 is illustrated as Data Record B 720 of FIG. 3b. Once the identity of the consumer has been determined, it can be used, e.g., to add data records to the exercised promotion table 615, to identify relevant records found in the consumer demographic table 616 or the consumer purchase history table 617, and/or to identify a suitable new promotion using analysis tools table 618.

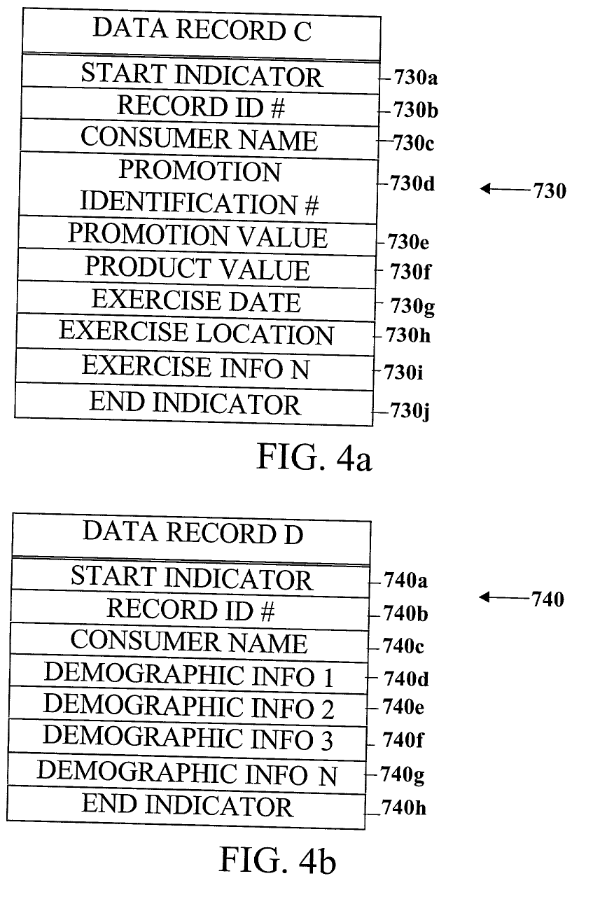

Adding a new record to the exercised promotion table 615 can be done once the identity of both the promotion and the consumer is available to the processor 611. This record can include further information that has not been discussed previously, such as the price of the product for which the promotion is being exercised, the store in which the product is being exercised, the value of the promotion, and the number of other promotions exercised simultaneously with a particular promotion. An exemplary data structure of a record included in exercised promotion table 615 is illustrated in data record C 730 of FIG. 4a. Once processor 611 stores the information related to the exercise of one or more promotions in exercised promotion table 615, this information can accessed by processor 611 for analysis to derive, e.g., one or more denominators related to promotion usage. These will be discussed in more detail later.

In some embodiments, the identity of the consumer can be used to locate a relevant record in consumer demographic table 616. Consumer demographic table 616 can contain data regarding the demographics of the individual consumer such as, e.g., age, profession, gender, race, education level, marital status, number of children, pet ownership, and other demographic factors. In one embodiment, this demographic information includes denominators related to promotion usage. Promotion usage denominators will be discussed in more detail later. An exemplary data structure of a record included in consumer demographic table 616 is illustrated in data record D 740 of FIG. 4b. Once processor 611 identifies the potential customer, the consumer's demographic information in consumer demographic table 616 can accessed by processor 611 to determine, in whole or in part, a suitable, targeted promotion for the individual.

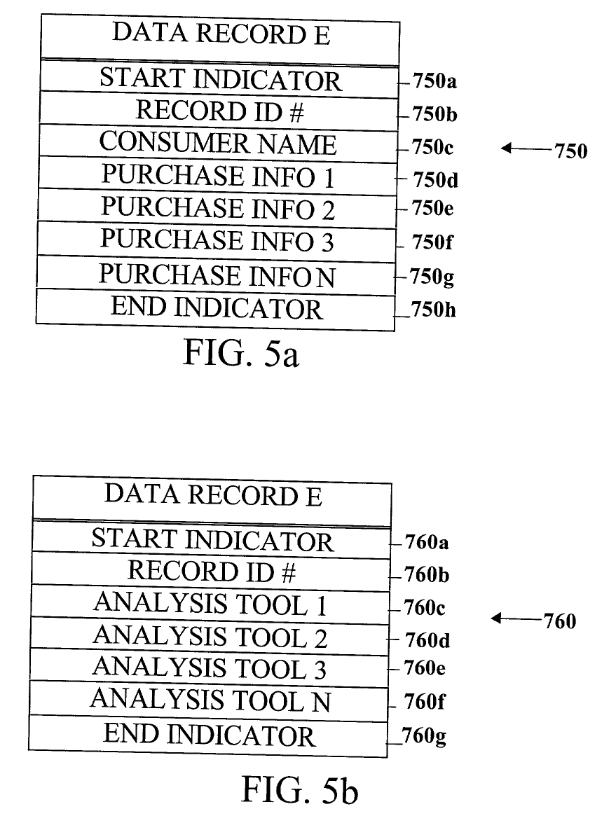

In some embodiments, the identity of the consumer can be used to locate a relevant record in consumer purchase history table 617. Consumer purchase history table 617 can contain data regarding the purchase history of the individual consumer such as, e.g., products previously purchased, the frequency of certain purchases, the name brands of certain purchases, the price of certain purchases (either in absolute terms or relevant to other available products), classes of products previously purchased, and locations where products are purchased. An exemplary data structure of a record included in consumer purchase history table 617 is illustrated in data record E 750 of FIG. 5a. Once processor 611 identifies the potential customer, the consumer's purchase history in consumer purchase history table 617 can accessed by processor 611 to determine, in whole or in part, a suitable, targeted promotion for the individual. Naturally, the consumer's demographic information in consumer demographic table 616 can be combined with the consumer's purchase history in consumer purchase history table 617 to more accurately identify a suitable promotion.

In some embodiments, a variety of information regarding analysis tools is stored in analysis tools table 618 of central database system 610. Analysis tools table 618 can contain data regarding, e.g., weighting coefficients for certain demographic and/or purchase record information, methods for analyzing various types of data, methods for extracting various types of data, methods for filtering various types of data, and/or other information that may help a practitioners of predictive targeting select suitable promotions based, at least in part, upon previous promotion usage. Plural versions of analysis tool information can be stored to accommodate the preferences of different practitioners of predictive targeting, seasonal variations, product classes, consumer class, and/or other factors as so desired. An exemplary data structure of a record included in analysis tools table 618 is illustrated in data record F 760 of FIG. 5b. One or more specific analysis tool records can be selected from analysis tools table 618 by a practitioner of targeted marketing as desired, using, e.g., a vendor interaction site 640 as discussed below. As with, e.g., the data tables 613, 614, 616, 617, and 618, analysis tools table 618 need not be included in central database system 610, but can instead be located at a vendor interaction site 680 as illustrated in FIG. 2.

Information related to suitable promotion or to determining a suitable promotion can be returned to vendor interaction site 630 by way of network 620 as desired, upon which the suitable promotion can be output using promotion output device 634. Promotion output device 634 can be any of a number of different devices, including a computer monitor, printers (paper or otherwise), magnetic writing devices (including disk drives, magnetic strip writers, tape writers), bar code writers, smart card writers, television screens, radio broadcast, Internet data transmission, print advertisement in a newspaper or newsletter, or simply electronic confirmations communicated automatically to another device, such as, for example, a check-out register or a credit card billing machine. In one embodiment, the promotion output device prints targeted coupons immediately after an identified consumer checks out at a supermarket cashier register.

Suitable promotions need not be output at the same vendor interaction site 630 (and/or simultaneously) where consumer identification and/or promotion information is received. This is illustrated explicitly by vendor interaction site 640, which shows a vendor interaction site without either a promotion or an identification input device. Rather, vendor interaction site 630 simply contains a request input device 646, through which a vendor wishing to practice predictive targeting can request the identification of a suitable promotion for a consumer and/or a suitable consumer for a promotion. This request is transmitted by processor 642 through network 620 to central database system 610, where information relating to a suitable promotion and/or a suitable consumer is identified, and returned to processor 642. Upon receipt of the information at processor 642, information relating to a suitable promotion and/or consumer is transmitted to promotion/address output device 644. If the request input at request input device 646 was for a consumer suitable for a certain promotion, then promotion/address output device 644 will output an address label, email address, and/or other information and/or item that insures that a promotion will be delivered to a suitable consumer. If the request input at request input device 646 was for a promotion suitable for a certain customer, then promotion/address output device 644 will output a suitable promotion for a consumer.

Request input device 646 can be a device such as a keyboard, touch screen, computer mouse, bar code reader, magnetic reader (including strip, disk, and tape reader), smart card reader, pressure sensor, motion detector, electromagnetic receiver, voltmeter, heat sensor, and other transducer capable of receiving request information. Promotion/address output device 644 can be any of a number of different devices, including a computer monitor, printers (paper or otherwise), magnetic writing devices (including disk drives, magnetic strip writers, tape writers), bar code writers, smart card writers, television screens, radio broadcast, Internet data transmission, print advertisement in a newspaper or newsletter, or simply electronic confirmations communicated automatically to another device, such as, for example, a check-out register or a credit card billing machine. In one embodiment, request input device 646 is a computer keyboard operated by a practitioner of targeted marketing, and promotion/address output device 644 is a address label printer used to provide a mail address to a suitable promotion.

Vendor interaction site 650, in addition to containing both a promotion input device 636 and an identification input device 638, also contains promotion identification table 613 and consumer identification table 614. This type of interaction site can be operated in conjunction with a central database system 610 as illustrated in FIG. 1, or with a central database system 610 as illustrated in FIG. 2. For example, the promotion identification table 613 could be dedicated to promotions that are valid only at the owner and/or operator of vendor interaction site 650, and the consumer identification table 614 could be dedicated to consumer identification information that is recognized only by the owner and/or operator of vendor interaction site 650. For example, if vendor interaction site 650 were owned and/or operated by a supermarket, “in-store” coupon identification information could be stored at promotion identification table 613 of vendor interaction site 650, and identification information relevant to that supermarket's (or supermarket chain's) frequent customer cards could be stored at consumer identification table 614 of vendor interaction site 650. However, if the consumer presented, e.g., a manufacturer's coupon or other identifying information such as a credit card, then vendor terminal 652 could access promotion identification table 613 and consumer identification table 614 central database system 610 to identify a promotion and/or consumer. Vendor interaction site 650 can also include a promotion output device (not shown), as discussed in regard to vendor interaction site 630.

Turning now specifically to FIG. 2, which shows further exemplary components of a network structure according to the present invention, these elements being used alone or in conjunction with the network structure shown in FIG. 1, the central database system 610 of FIG. 2 has been pared down to an exercised promotion table 615. In this case, some or all of the functionality previously ascribed to the central database system 610 of FIG. 1 can be transferred in whole or in part to one or more components. For example, the other database system 660 now contains consumer demographic table 616 and consumer purchase history table 617. The other database system 660 can be owned and/or operated by, e.g., a third party and/or a practitioner of targeted marketing. In this way, a practitioner of targeted marketing can use other demographic and/or historical purchase information to target promotions. This is especially relevant to a practitioner of targeted marketing who is using exercised promotion data that does not originate in the practitioner's industry and/or product type and/or class. For example, even though a vendor of telephone services uses exercised promotion information that was collected at a supermarket, this vendor of telephone services may desire to use other demographic and/or consumer purchase history information, such as that collected by the vendor itself.

Also illustrated in FIG. 2 is a vendor identification site 630 that does not include a promotion input device 636. The lack of a promotion input device 636 is intended to explicitly illustrate that no promotion need be used in order for a practitioner of targeted marketing to provide a promotion to a consumer. Any time that a consumer is identified using identification input device 638, one or more targeted promotions can be output at promotion output device 634. This embodiment of vendor identification site 630 is particularly useful for small vendors that manually enter promotions, for vendors where promotions are not common and/or accepted (such as, e.g., physician's offices, legal offices, etc.), or when the vendor interaction site 630 is not used to conduct an actual purchase transaction, such as a vendor interaction site 630 that is formed by an individual's home computer.

Vendor interaction site 640 of FIG. 2 includes an analysis tools table 618 such as found at the central database system 610 of FIG. 1. The analysis tools table 618 at vendor interaction site 640 allows a vendor to develop and store individualized and/or proprietary analysis tools. Thus, data drawn from, e.g., an exercised promotion table 615, consumer demographic table 616, and/or consumer purchase history table 617 can be transmitted over network 640 in response to a request from the processor 642 of vendor interaction site 640 and analyzed at the same processor 642 using analysis tools stored in analysis tools table 618. This allows a practitioner of predictive targeting to maintain control over the analysis tools and/or results of analysis.

FIG. 3a and 3b illustrate two different data record structures 710 and 720 that may be used in promotion identification table 613 and consumer identification table and 614 of FIGS. 1 and 2. Promotion identification number 710c of promotion record 710 is compared promotion identification information received at promotion input device 636. Once a suitable match is found, the product field 710d, which identifies the product of the identified promotion, is used to determine if the consumer is presenting a promotion that is germane to a particular transaction. This can be done by, e.g,. comparing product field 710d to a list of products that the consumer wishes to purchase or simply by providing a vendor with the product identification information stored in product field 710d. The time field 710e stores information related to the time of validity of the promotion and is used to determine if the consumer is presenting a promotion in a timely fashion since many promotions are valid only at certain times. This can be done by, e.g,. comparing time field 710e to a current date or simply by providing a vendor with the time validity information stored in time field 710e. The source field 710f identifies the source of the promotion (e.g., local franchise, manufacturer, or even a competitor) and is used to determine if the consumer is presenting a promotion to a suitable vendor since many promotions are valid only at certain vendors. This can be done by, e.g,. comparing source field 710f to vendor identification information provided by a vendor interaction site or simply by providing a vendor with the source information stored in source field 710f. The value field 710g identifies the value of the promotion either in absolute (e.g., a one dollar off coupon) or relative (e.g., a 10% off coupon) terms and is used, e.g., to determine the price that a consumer must pay for a product. This can be done by, e.g,. providing a vendor with the value information stored in value field 710g.

Consumer identification record 720 is used to identify a consumer using information input at, e.g., identification input device 638. One or more identification factors input at an identification input device 638 can be compared to identification factor records 720d, 720e, and 720f to determine or confirm the identity of the individual identified in consumer name field 720c. When identity is being confirmed, the relevant consumer identification record 720 is first located using consumer name field 720c, but when identity is being determined, the relevant consumer identification record 720 is first located using identification factor records 720d, 720e, and 720f to locate a match or a near match. Regardless of whether a confirmation or determination is performed, after it has been completed, a consumer will be identified. Consumer information field 720g is optional and may include information related to the consumer such as, e.g., the address of the consumer, the location of further demographic and/or consumer purchase history related to the consumer or even the demographic and/or consumer purchase history information itself FIGS. 4a and 4b illustrate two different data record structures 730 and 740 that may be used to store data regarding exercised promotions in exercised promotion table 615 and data regarding a particular consumer's demographic information in consumer demographic tables 616 of FIGS. 1 and 2. Exercised promotion record 730 is used to store information related to the promotions that a consumer has exercised. The consumer's name is stored in field 730c, and promotion identification information such as a promotion identification number is stored in field 730d. Field 730e stores the value of the promotion identified in field 730d. Storing both promotion identification information and promotion value information in record 730 may appear redundant, especially in light of the fact that the promotion identification information can be used, in conjunction with the data stored in promotion identification table 613, to identify the value of the promotion. However, in the illustrated embodiment of an exercised promotion record 730, both identification information and value information is stored since many promotions have values that depend upon, e.g., amount purchased, time of purchase, or even location of purchase, since some vendors may, e.g., “double” or “triple” certain coupons. The inclusion of both identification information and value information also speeds analysis, since extensive database searches need not be performed. Field 730f of exercised promotion record 730 is used to store the product value at time of use. This is desirable since a promotion may be denominated in absolute terms, whereas an analysis tool may require the promotion value in relative (% of total cost) terms. Field 730g describes the date that the promotion was exercised to allow a practitioner of predictive targeting to monitor the frequency and/or change in frequency of promotion use. Field 730h describes the location where a promotion is used, so that a practitioner of predictive targeting can monitor the patterns in location of promotional usage. This is relevant since, e.g., a consumer may exercise promotions more extensively at certain types or locations of stores more often than at others, and this can be used to increase a predictive targeting practitioner's accuracy in determining the likelihood that a particular promotion will be exercised. Further usage information N can be stored in field 730i. This further usage information may be related to, e.g., the number of promotions used simultaneously, an estimated time required for the consumer to exercise the promotion, a broad class of goods and/or services into which the product falls, and/or other factors related to the exercise of the promotion. It is only necessary that these factors can be used to increase the accuracy of predictive targeting.

Consumer demographic record 740 is used to store information related to the demographics of a consumer. The consumer's name is stored in field 740c and various demographic information is stored in fields 740d, 740e, 740f, and 740g. This demographic information can relate to, e.g., a consumer's age, profession, gender, race, education level, marital status, number of children, pet ownership, and other demographic factors.

FIGS. 5a and 5b illustrate two different data record structures 750 and 760 that may be used to store data regarding a consumer's purchase history in purchase history table 616 and data regarding one or more analysis tools in analysis tools tables 618 of FIGS. 1 and 2. Consumer purchase history 750 is used to store information related to past purchases by the consumer, regardless of promotion usage. The consumer's name is stored in field 750c, and purchase information such as a product purchased, product price, date of purchase, location of purchase, and/or other purchase history information is stored in fields 750d, 750e, 750f, and 750g.

Analysis tools record 760 is used to store information in an analysis tools table 618 as illustrated in FIGS. 1 and 2. This information is related to one or more analysis tools for use by a practitioner of predictive targeting to determine one or more promotion usage denominators. Fields 760c, 760d, 760e, and 760f of analysis tools record 760 contain, e.g, computer processor instructions and/or other information needed to perform an analysis of the data stored in records 730, 740, 750, and/or even 720 to determine the likelihood that a consumer will exercise a promotion. For example, a predictive targeting practitioner who wishes to provide a large absolute value promotion (e.g., $400.00 off a purchase of $10,000.00 or more) that is valid only at a relatively high end merchandiser (e.g., Tiffany's) will search for consumers who tend to exercise high absolute value promotions regardless of the relative value of those promotions. Thus, instructions contained in analysis tools record 760 can be used to identify consumers possessing certain promotion usage denominators based upon an exercised promotion history that indicates that the absolute value of a promotion exercised is highly correlated and the relative value of a promotion exercised is poorly correlated with likelihood of exercise. Determinations across the traditional boundaries of product class can also be made. For example, if a telephone service provider wishes to identify consumers that are likely to exercise a relatively small absolute value but relatively large relative value promotion (e.g., a 1 cent/minute discount on phone service costing 10 cents/minute), he or she could select consumers that have exercised similar promotions in e.g., the packaged goods industry for targeting. Similar selections and/or identifications can be made on the basis of, e.g., stores where a consumer is likely to exercise promotions, products for which a consumer is likely to exercise promotions, packaging of the promotion (including, e.g., color, size, shape), and how promotions that a consumer has exercised were delivered to the consumer. For example, a consumer who consistently refuses to exercise promotions delivered by telephone might not be a suitable candidate for a telemarketing campaign, and a correlation coefficient determined using analysis tools record 760 between this type of promotion delivery and likelihood of use would be small.

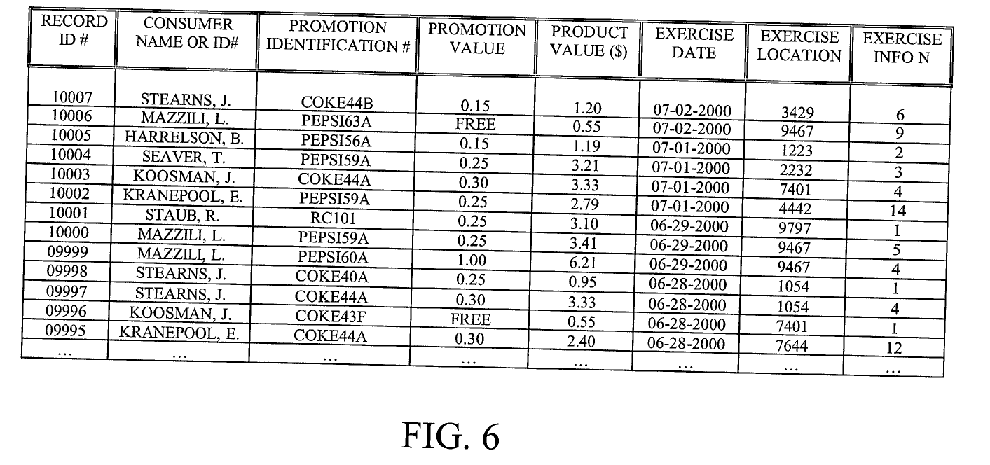

FIG. 6 is an exemplary data table using plural exercised promotion records 730 for storing exercised promotion records according to the date when a promotion was exercised. Exemplary (and, due to length considerations, statistically insignificant) promotion usage denominators from the exercised promotion records can be determined on the basis of the illustrated data. For example, the consumer Kranepool, E. exercises promotions for any product, as long as the relative value of the promotion is high. Moreover, if the “Use Info N” field is directed to the number of promotions exercised at a single time, then the consumer Kranepool, E. appears to exercise a relatively large number of promotions. As such, a practitioner of predictive targeting who provides high relative value promotions may find a particularly receptive candidate for such promotions in consumer Kranepool, E. On the other hand, the consumers Steams, J. and Mazzili, L. may exercise promotions relatively often, but they appear to be loyal to certain product manufacturers regardless of the relative or absolute value of the promotion. As such, a promotion from a manufacturer who is not the manufacturer to whom they are currently loyal would presumably have to be of relatively high relative and/or absolute value to be exercised. Thus, a practitioner of predictive targeting for other manufacturers could either select to provide a relatively high relative and/or absolute value promotion or provide no promotion to these consumers at all, based upon the low likelihood that the promotion will be exercised.

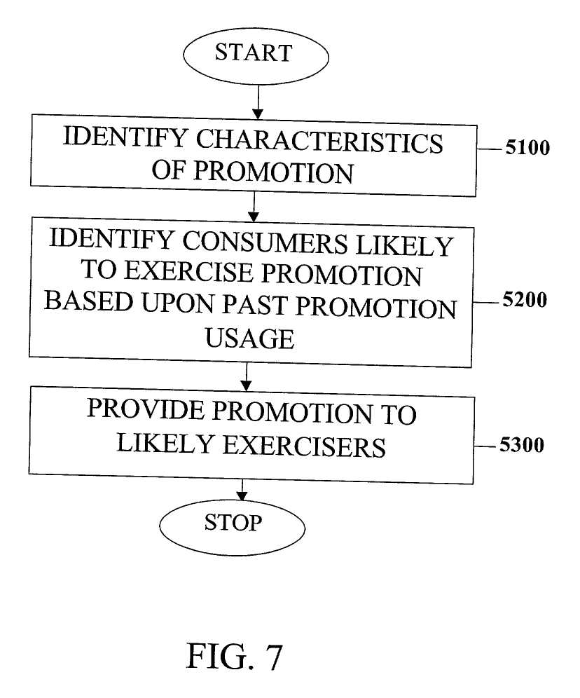

FIG. 7 is a flow chart that illustrates an exemplary promotion-driven method for performing the present invention This method is denoted as “promotion-driven” since the nature of the promotion drives the selection of consumers. This is particularly relevant in industries where the nature of promotions is quite limited due to, e.g., nature of the products, low profit margins, frequency of purchases by consumers, and/or historical promotions within an industry. For example, a durable-goods retailer might not be able to offer a “buy one, get one free” promotion, whereas a free service warranty would be useless for consumable and/or disposable goods. “Promotion-driven” method are also particularly relevant to promotions provided across the boundaries of product industry and/or product type and/or class. For example, a telephone service provider may only be able to provide ten or fifteen different types of promotions. By finding consumers who are likely to exercise one of these ten or fifteen different types of promotions using the promotions previously exercised in, e.g., the packaged goods industry, the costs of distributing promotions and associated with the exercise of the promotions themselves can be reduced.

In step 5100, the characteristics of a predetermined promotion are identified and used to classify the promotion according to the identified characteristics of the promotion. These characteristics can include, e.g., the relative value of the promotion, the absolute value of the promotion, the time allowed for exercise of the promotion, other purchases necessary to exercise the promotion, locations where the promotion can be exercised, the method by which the promotion will be delivered to the consumer, the language, color, and/or other packaging of the promotion, and/or any other characteristics of the promotion. The characteristics can be stored in a separate new promotion record, similar to the exercised promotion record 730 illustrated in FIG. 4a, but with fields reflecting, e.g., potential product values, potential use dates, potential use locations, etc. rather than exercised values, exercised date, etc.

In step 5200, one or more consumers who are likely to exercise such a promotion are identified. This can be done by using one or more analysis tools stored, e.g., in analysis tools table 618 of FIG. 1. For example, a correlation coefficient that indicates that a consumer has a promotion usage denominator associated with being likely to exercise high relative value promotions (optionally combined with a historical purchase record of a certain product and/or one or more demographic indicators that indicates a consumer is likely to purchase a product) can be used to identify consumers who are likely to exercise a particular high relative value promotion.

In step 5300, the promotions are provided to likely exercisers. This can be done, e.g., using a promotion output device 634 described in FIGS. 1 and 2. Naturally, step 5300 need not be performed by the same entity who performs steps 5200 and/or 5100. Rather, only information used to perform step 5300 need be provided.

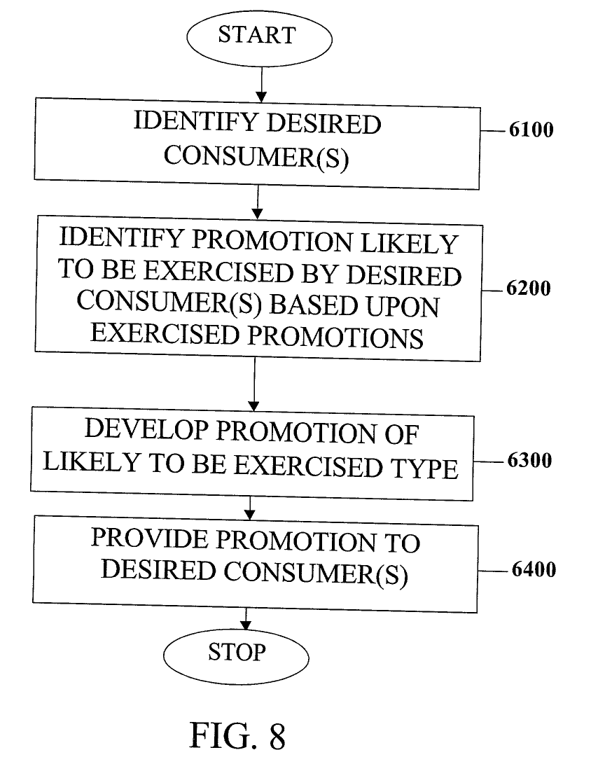

FIG. 8 is a flow chart that illustrates an exemplary consumer-driven method for performing the present invention. This method is denoted as “consumer-driven” since the nature of the consumer drives the selection of promotions. This is particularly relevant in industries where the nature of the consumer is quite vital due to, e.g., the instantaneous presence of a consumer at a particular location, a limited number of consumers in a geographic location, particular consumer(s) having particular demographic characteristics, the desirability of a certain consumer demographic, and/or other reasons that a practitioner of predictive targeting might want to obtain a certain consumer(s). For example, a consumer may be instantaneously present at the checkout cashier of a supermarket. As another example, a SAAB dealer in a rural community might only have a limited number of potential SAAB consumers within that rural community and might need to target those individuals directly. As a yet further example, a magazine may desire a certain reader demographic so that it can charge certain fees to advertisers. Thus, by targeting consumers within the appropriate demographic group using promotions determined at least in part based upon the exercise of promotions by individuals within that group, the magazine may be able to increase its readership within the targeted demographic group. “Consumer-driven” methods are also relevant to promotions provided across the boundaries of product industry and/or product type and/or class. For example, a telephone service provider may wish to increase it's subscriber rate within a geographic region to allay the costs of investing in new infrastructure in that region Although the telephone service provider may have no information regarding the exercise of promotions within the telecom industry, by accessing records relating to the exercise of promotions in e.g., the packaged goods industry, suitable consumers can be identified. By issuing promotions that are likely to be exercised by the desired consumers, the costs of distributing promotions and associated with the exercise of the promotions themselves can be reduced.

In step 6100, the desired consumers are identified. This can include receiving a list of desired consumers from a third party, or accessing internal records to identify desired consumers. Desired consumers can be identified using, e.g., consumer identification table 614 alone or in conjunction with consumer demographic table 616, exercised promotion table 615, and/or consumer purchase history table 617.

In step 6200, a promotion likely to be exercised by a desired consumer based at least in part upon past promotion usage is identified. This can be done as described in regard to FIG. 6, where past promotion exercise is used to determine a new promotion that is likely to be exercised. For example, if a consumer has often exercised high relative value promotions that are delivered by mail, then his type of promotion can be identified as likely to be used.

In step 6300, the new promotion that is likely to be exercised is actually developed. This may be done within the confines of the industry of the new promotion. In regard to the example described in step 6200, a high relative value promotion suitable for mailing can be developed by the practitioner of predictive targeting.

In step 6400, the new promotion is provided to the desired consumer. This can be done, e.g., using a promotion output device 634 described in FIGS. 1 and 2. Naturally, steps 6300 and 6400 need not be performed by the same entity who performs steps 6200 and/or 6100. Rather, only information used to perform steps 6300 and 6400 need be provided.

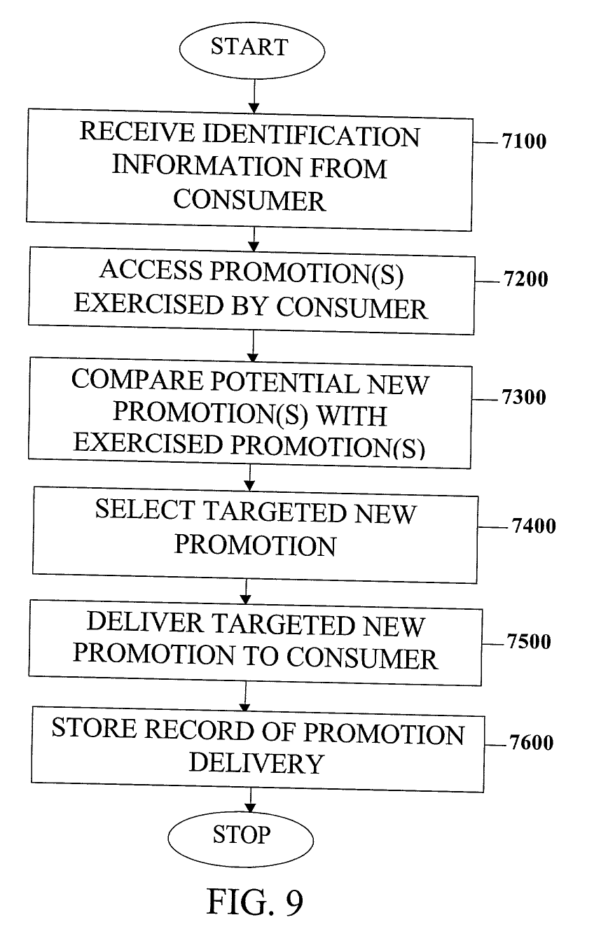

FIG. 9 illustrates consumer-driven method for providing targeted promotions based upon exercised promotions that is driven by the instantaneous presence of a consumer at a particular location. For example, this method could be performed when a consumer is checking out at a supermarket. In step 7100, identification information is received from a consumer. This information could be received using, e.g., an identification input device 638 as illustrated in FIGS. 1 and 2. In step 7200, data related to the promotions exercised by the identified consumer are accessed. This data can include either a list of the previously exercised promotions such as found in exercised promotion table 615, or it could include one or more parameters derived from a list of the previously exercised promotions such as found in exercised promotion table 615 using, e.g., one or more analysis tools such as found in analysis tools table 618 of FIG. 1. Thus, a promotion exercise profile can be accessed in step 7200. Whether the raw data or a derived parameter is accessed, in step 7300, the data related to exercised promotions is compared with potential new promotions, and in step 7400 a targeted promotion is selected. The potential new promotion(s) of step 7300 need not originate from different customers and/or relate to different products, but in one embodiment they do. As such, when a promotion for a particular product from a particular manufacturer is selected in step 7400, the particular manufacturer will ultimately be issued a bill. Naturally, the promotion selected in step 7400 can also be no promotion if no suitable promotion is found.

In step 7500, the targeted new promotion is delivered to a consumer who is likely to exercise the promotion. This can be done, e.g., using a promotion output device 634 described in FIGS. 1 and 2. Naturally, step 7500 need not be performed by the same entity who performs steps 7100, 7200, 7300, and/or 7400. Rather, only information used to perform step 7500 need be provided.

In step 7600, a record of the delivery of the promotion to the consumer is recorded. This information can be used to, e.g., bill a client and/or create a data table similar to exercised promotion table 615 related to delivered promotions. In such a case, analysis based at least in part upon exercised promotions can include the promotions that were not exercised by a consumer.

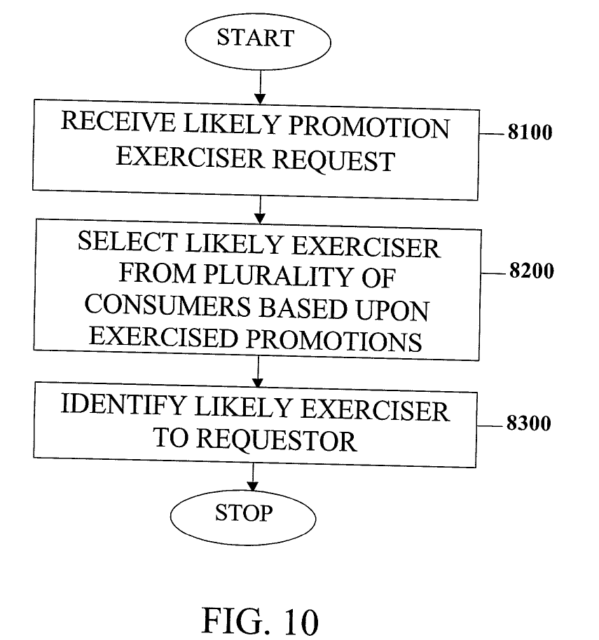

FIG. 10 illustrates a promotion-driven method for performing the invention where the performer of the invention need only operate a processor 611 in conjunction with an exercised promotion table 615 and an analysis tools table 618. A request for information identifying consumers who are likely to exercise a promotion is received in step 8100. This request can indicate that a company wishes to distribute a certain promotion to individuals. In step 8200, consumers who are likely to exercise the promotion are selected from a larger group of consumers based at least in part on promotions exercised. This can be done by identifying characteristics of a new promotion and identifying consumers that are likely to respond to those characteristics by exercising the promotion. In step 8300, those consumers likely to exercise are identified to the requestor of information identifying consumers.

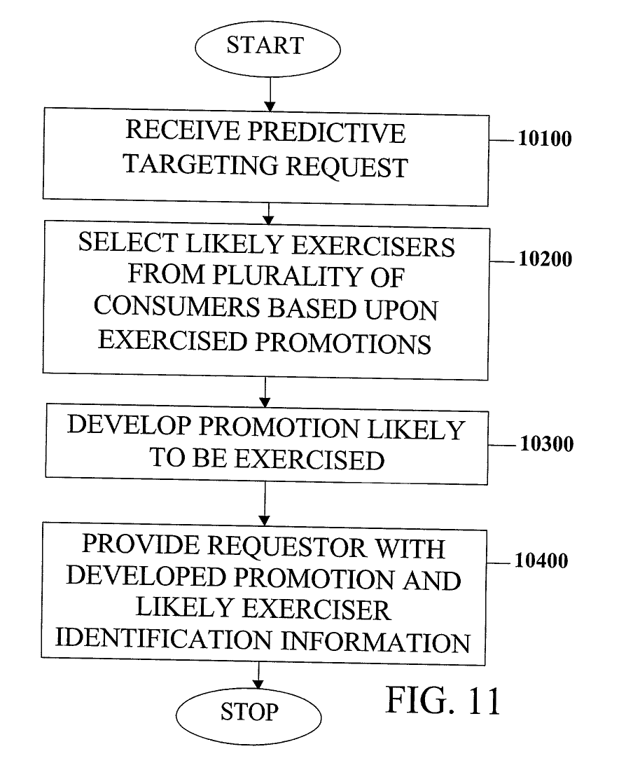

FIG. 11 illustrates a method for performing the invention where the performer of the invention need only operate a processor 611 in conjunction with an exercised promotion table 615 and an analysis tools table 618. A request for predictive targeting services is received in step 10100. This request indicates that a company wishes to distribute promotions to individuals and can include, e.g., a number of promotions to be delivered, a relative and/or absolute value of the promotions, a desired exercise rate for the promotions, the characteristics (e.g., location, demographics, etc) of consumers who should exercise the promotions, a type of promotion, and/or other information. This request can include both consumer and promotion information, so that this development will include both consumer-driven and promotion-driven characteristics.

In step 10200, consumers who are likely to exercise the promotion are selected from a larger group of consumers based at least in part on promotions exercised. This can be done using characteristics of a consumer and/or a promotion received in step 10100 and identifying consumers that are, e.g., desirable to the requester.

In step 10300, promotions which the identified consumer are likely to exercise are developed. This development can include, e.g., weighing the value of promotions against the number of promotions to be exercised, weighing the desirability of individual consumers against the promotional cost of having those consumers advertise the promotion, and/or other factors that, in one embodiment, relate to the characteristics of a consumer and/or a promotion received in step 10100.

In step 10400, the requestor is provided with both likely exerciser identification information and promotions likely-to be exercised information. This information can include, e.g., a list of addresses of consumers, and various promotion

types likely to be exercised by consumers at the listed addresses. Naturally, the promotion(s) can also be directly provided to the likely exercisers if desired, as shown in step 7500 of FIG. 9.

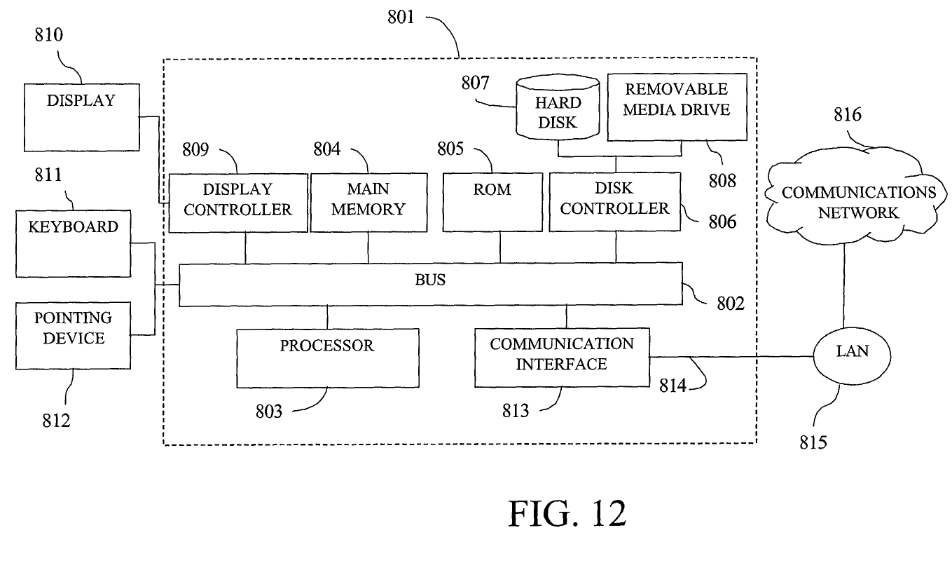

FIG. 12 illustrates a computer system 801 that can form several different units in an embodiment of the present invention. For example, computer system 801 can alternately form the central database system 610, a vendor interaction site 630, 640, or 650, or an other database system 660 of FIGS. 1 and 2. For this reason, the computer system 801 will be described using unique reference numerals. When a part of computer system 801 that is analogous to a part in another figure is described, this will be stated in the text. Computer system 801 includes a bus 802 or other communication mechanism for communicating information, and a processor 803 coupled with bus 802 for processing the information. Processor 803 can form processor 611 or 643 and/or one or more of the vendor terminals 632, 642, or 652 of FIGS. 1 and 2. Computer system 801 also includes a main memory 804, such as a random access memory (RAM) or other dynamic storage device (e.g., dynamic RAM (DRAM), static RAM (SRAM), synchronous DRAM (SDRAM), flash RAM), coupled to bus 802 for storing information and instructions to be executed by processor 803. In addition, main memory 804 may be used for storing temporary variables or other intermediate information during execution of instructions to be executed by processor 803. Computer system 801 further includes a read only memory (ROM) 805 or other static storage device (e.g., programmable ROM (PROM), erasable PROM (PROM), and electrically erasable PROM (EEPROM)) coupled to bus 802 for storing static information and instructions for processor 803. A hard disk 807 and/or removable media drive 808, such as a magnetic disk or optical disk, is provided and coupled to bus 802 by way of a disk controller 806 for storing information and instructions. Hard disk 807 and/or removable media drive 808 can contain the tables 613, 614, 615, 616, 617, and 618 of FIGS. 1 and 2.

The computer system 801 may also include special purpose logic devices (e.g., application specific integrated circuits (ASICs)) or configurable logic devices (e.g., generic array of logic (GAL) or reprogrammable field programmable gate arrays (FPGAs)). Other removable media devices (e.g., a compact disc, a tape, and a removable magneto-optical media) or further fixed, high density media drives, may be added to the computer system 801 using an appropriate device bus (e.g., a small computer system interface (SCSI) bus, an enhanced integrated device electronics (IDE) bus, or an ultra-direct memory access (DMA) bus). Such removable media devices and fixed, high density media drives can also contain the tables 613, 614, 615, 616, 617, and 618 of FIGS. 1 and 2. The computer system 801 may additionally include a compact disc reader, a compact disc reader-writer unit, or a compact disc juke box, each of which may be connected to the same device bus or another device bus.

Computer system 801 may be coupled via bus 802 to a display 810, such as a cathode ray tube (CRT), for displaying information to a computer user. Display 810 can form a promotion and/or address output device 634 or 644 of FIGS. 1 and 2, especially when the vendor site is an individual's home computer and the promotion is an advertisement. The display 810 may be controlled by a display or graphics card. The computer system includes input devices, such as a keyboard 811 and a pointing device 812 (e.g., a cursor control), for communicating information and command selections to processor 803. The keyboard 811 and a pointing device 812 (e.g., a cursor control) can form a promotion, identification, and/or request input device 636, 638, and/or 646 of FIGS. 1 and 2. The pointing device 812 (e.g., cursor control), for example, is a mouse, a trackball, or cursor direction keys for communicating direction information and command selections to processor 803 and for controlling cursor movement on the display 810. In addition, a printer (not shown) may provide a promotion and/or address output device 634 or 644 of FIGS. 1 and 2, especially wherein the promotion is a coupon at the cashier of a supermarket.

The computer system 801 performs a portion or all of the processing steps of the invention in response to processor 803 executing one or more sequences of one or more instructions contained in a memory, such as the main hard disk memory 807. Such instructions may be read into the main hard disk memory 807 from another computer readable medium, such as removable media drive 808. Thus, either the main hard disk memory 807 or the removable media drive 808 can include the analysis tools table 618. One or more processors in a multi-processing arrangement may also be employed to execute the sequences of instructions contained in main hard disk memory 807. In alternative embodiments, hard-wired circuitry may be used in place of or in combination with software instructions. Thus, embodiments are not limited to any specific combination of hardware circuitry and software.

As stated above, the system 801 includes at least one computer readable medium or memory programmed according to the teachings of the invention and for storing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the computer system 801, for driving a device or devices for implementing the invention, and for enabling the computer system 801 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium or media that participate in providing instructions to processor 803 for execution. A computer readable medium may take many forms, including but not limited to, non-volatile media, volatile media, and transmission media. Non-volatile media includes, for example, optical, magnetic disks, and magneto-optical disks, such as hard disk 807 and/or removable media drive 808. Transmission media includes coaxial cables, copper wire and fiber optics, including the wires that comprise bus 802. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 803 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 801 may receive the data on the telephone line and use an infrared transmitter to convert the data to an infrared signal. An infrared detector coupled to bus 802 can receive the data carried in the infrared signal and place the data on bus 802. Bus 802 carries the data to main hard disk memory 807, from which processor 803 retrieves and executes the instructions. The instructions received by main hard disk memory 807 may optionally be stored on a removable media storage device 808 either before or after execution by processor 803.

Computer system 801 also includes a communication interface 813 coupled to bus 802. As described previously, communication interface 813 can itself form a promotion and/or address output device 634 and 644 when an electronic promotion and/or address data is communicated electronically to another device such as a computer, cash register, credit-card billing device, coupon printer, etc. Such electronic promotions can include, for example, electronic codes automatically transmitted to the register of a vendor, electronic data describing an advertisement to a consumer's personal computer, or deductions from a customer's account upon purchase or order of a product. Communication interface 813 provides a two-way data communication coupling to a communications network 816 that is connected to a local network 815. For example, communication interface 813 may be a network interface card to attach to any packet switched local area network (LAN). As another example, communication interface 813 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 813 sends and receives electrical, electromagnetic or optical signals that carry digital data streams representing various types of information.

Communications network 816 typically provides data communication through one or more networks to other data devices. For example, communications network 816 may provide a connection to another computer (not shown) through local network 815 (e.g., a LAN) or through equipment operated by a service provider, which provides communication services through a communications network 816. Communications network 816 can form network 620 of FIGS. 1 and 2. According to one embodiment, computer 801 is one of the interactions sites 630 while central database system 610 is formed by another computer 801. In some embodiments, local network 815 and communications network 816 preferably use electrical, electromagnetic, or optical signals that carry digital data streams. The signals through the various networks and the signals on network link 814 and through communication interface 813, which carry the digital data to and from computer system 801, are exemplary forms of carrier waves transporting the information. Computer system 801 can transmit notifications and receive data, including program code, through the network(s), network link 814 and communication interface 813.

Obviously, numerous modifications and variations of the present invention are possible in light of the above teachings. It is therefore to be understood that within the scope of the appended claims, the invention may be practiced otherwise than as specifically described herein.

1. A method comprising steps of:
receiving identification information from a consumer,
identifying said consumer based upon said received identification information;
retrieving an exercised promotions denominator related to a promotion exercised by said identified consumer; and
determining a targeted promotion likely to be exercised based at least in part upon said retrieved exercised promotions denominator.

2. The method according to claim 1, further comprising providing said targeted promotion to said consumer.

3. The method according to claim 1, further comprising providing information related to said targeted promotion to a third party.

4. The method according to claim 1, wherein said determining step comprises comparing a potential targeted promotion with said exercised promotions denominator.

5. The method according to claim 1, wherein said determining step comprises determining a likelihood that a potential targeted promotion will be exercised by said consumer.

6. The method according to claim 5, wherein said determining a likelihood step comprises comparing a characteristic of said potential targeted promotion with said exercised promotions denominator.

7. The method according to claim 6, wherein said exercised promotions denominator comprises an exercised promotion relative value denominator.

8. The method according to claim 6, wherein said exercised promotions denominator comprises an exercised promotion absolute value denominator.

9. The method according to claim 6, wherein said exercised promotions denominator comprises an exercised promotion delivery method denominator.

10. The method according to claim 6, wherein said exercised promotions denominator comprises an exercised promotion exercise location denominator.

11. The method according to claim 6, wherein said exercised promotions denominator comprises an exercised promotion promoted product denominator.

12. The method according to claim 6, wherein said exercised promotions denominator comprises an exercised promotion class denominator.

13. The method according to claim 6, wherein said exercised promotions denominator comprises an exercised promotion frequency denominator.

14. The method according to claim 1, wherein:
said exercised promotions denominator is related to a promotion exercised in a first industry; and
said targeted promotion is for a second product in a second industry.

15. The method according to claim 14, wherein said first industry comprises a packaged goods industry.

16. The method according to claim 1, wherein:
said exercised promotions denominator is related to a promotion exercised in a first product class; and
said targeted promotion is for a second product in a second product class.

17. The method according to claim 16, wherein said first product class comprises goods and said second product class comprises services.

18. The method according to claim 1, wherein:
said exercised promotions denominator is related to a promotion exercised for a first product class; and
said targeted promotion is for a second product in a second product class.

19. The method according to claim 18, wherein said first product class comprises goods found at a supermarket.

20. A method comprising steps of:
obtaining promotion information related to a particular promotion;
comparing said received promotion information to a plurality of exercised promotion denominators based on promotions exercised by a plurality of consumers; and
selecting a targeted consumer from said plurality of consumers based at least in part upon said plurality of exercised promotion denominators, said targeted consumer being likely to exercise said particular promotion.

21. The method according to claim 20, further comprising providing said particular promotion to said targeted consumer.

22. The method according to claim 20, further comprising providing information related to said targeted consumer to a third party.

23. The method according to claim 20, wherein said selecting step comprises comparing said particular promotion with said plurality of exercised promotion denominators.

24. The method according to claim 20, wherein said selecting step comprises determining a likelihood that said particular promotion will be exercised by said targeted consumer.

25. The method according to claim 24, wherein said determining step comprises comparing a characteristic of said particular promotion with said plurality of exercised promotion denominators.

26. The method according to claim 25, wherein said plurality of exercised promotion denominators comprise a plurality of exercised promotion relative value denominators.

27. The method according to claim 25, wherein said plurality of exercised promotion denominators comprise a plurality of exercised promotion absolute value denominators.

28. The method according to claim 25, wherein said plurality of exercised promotion denominators comprise a plurality of exercised promotion delivery method denominators.

29. The method according to claim 25, wherein said plurality of exercised promotions denominators comprise a plurality of exercised promotion exercise location denominators.

30. The method according to claim 25, wherein said plurality of exercised promotion denominators comprise a plurality of exercised promotion promoted product denominators.

31. The method according to claim 25, wherein said plurality of exercised promotion denominators comprise a plurality of exercised promotion class denominators.

32. The method according to claim 25, wherein said plurality of exercised promotion denominators comprise a plurality of exercised promotion frequency denominators.

33. The method according to claim 20, wherein:
said plurality of exercised promotion denominators is related to a plurality of first promotions exercised in a first industry; and
said particular promotion is for a second product in a second industry.

34. The method according to claim 33, wherein said first industry comprises a packaged goods industry.

35. The method according to claim 20, wherein:
said plurality of exercised promotion denominators is related to a plurality of first promotions exercised in a first product class; and
said particular promotion is for a second product in a second product class.

36. The method according to claim 35, wherein said first product class comprises goods and said second product class comprises services.

37. The method according to claim 20, wherein:
said plurality of exercised promotion denominators is related to a plurality of first promotions exercised for a first product class; and
said particular promotion is for a second product in a second product class.

38. The method according to claim 37, wherein said first product class comprises goods found at a supermarket.

39. A method comprising:
receiving a request for a provision of targeted promotions, said request including at least one parameter related to said provision of targeted promotions;
selecting likely exercisers of a targeted promotion from a plurality of consumers based at least in part upon promotions exercised by said likely exercisers;
determining a targeted promotion likely to be exercised by said likely exercisers based at least in part upon promotions exercised by said likely exercisers; and
providing information related to at least one of said selected likely exercisers and said determined targeted promotion,
wherein said at least one parameter related to said provision of targeted promotions is used in at least one of said selecting step and said determining step.

40. The method according to claim 39, wherein said providing information step comprises providing said selected likely exercisers with said determined targeted promotion.

41. The method according to claim 39, wherein said providing information step comprises providing a list of said selected likely exercisers to a party having made said request for a provision of targeted promotions.

42. The method according to claim 39, wherein said at least one parameter related to said provision of targeted promotions comprises a class of targeted promotion.

43. The method according to claim 39, wherein said determining step comprises comparing a characteristic of said targeted promotion with said plurality of exercised promotion parameters.

44. The method according to claim 39, wherein said at least one parameter related to said provision of targeted promotions comprises a total value of promotions to be exercised.

45. The method according to claim 39, wherein said at least one parameter related to said provision of targeted promotions comprises a total number of promotions to be exercised.

46. The method according to claim 39, wherein said determining step comprises comparing a characteristic of promotions exercised by said likely exercisers with a characteristic of said targeted promotion.

47. The method according to claim 46, wherein said characteristic of promotions exercised by said likely exercisers and said characteristic of said targeted promotion both comprise a relative value.

48. The method according to claim 46, wherein said characteristic of promotions exercised by said likely exercisers and said characteristic of said targeted promotion both comprise an absolute value.

49. The method according to claim 46, wherein said characteristic of promotions exercised by said likely exercisers and said characteristic of said targeted promotion both comprise a delivery method.

50. The method according to claim 46, wherein said characteristic of promotions exercised by said likely exercisers and said characteristic of said targeted promotion both comprise an exercise location.

51. The method according to claim 46, wherein said characteristic of promotions exercised by said likely exercisers and said characteristic of said targeted promotion both comprise a promoted product.

52. The method according to claim 46, wherein said characteristic of promotions exercised by said likely exercisers and said characteristic of said targeted promotion both comprise a class of promotion.

53. The method according to claim 46, wherein said characteristic of promotions exercised by said likely exercisers and said characteristic of said targeted promotion both comprise an exercise frequency of promotion.

54. The method according to claim 39, wherein:
said promotions exercised by said likely exercisers are related to a plurality of first promotions exercised in a first industry; and
said targeted promotions are for a second product in a second industry.

55. The method according to claim 54, wherein said first industry comprises a packaged goods industry.

56. The method according to claim 39, wherein:
said promotions exercised by said likely exercisers are related to a plurality of first promotions exercised in a first product class; and
said targeted promotions are for a second product in a second product class.

57. The method according to claim 56, wherein said first product class comprises goods and said second product class comprises services.

58. The method according to claim 39, wherein:
said promotions exercised by said likely exercisers are related to a plurality of fist promotions exercised for a first product class; and
said targeted promotions are for a second product in a second product class.

59. The method according to claim 58, wherein said first product class comprises goods found at a supermarket.

60. A system, comprising:
means for receiving identification information from a consumer;
means for identifying said consumer based upon said received identification information;
means for retrieving an exercised promotions denominator related to a promotion exercised by said identified consumer; and
means for determining a targeted promotion likely to be exercised based at least in part upon said retrieved exercised promotions denominator.

61. A system, comprising:
means for obtaining promotion information related to a particular promotion;
means for comparing said received promotion information to a plurality of exercised promotion denominators based on promotions exercised by a plurality of consumers; and
means for selecting a targeted consumer from said plurality of consumers based at least in part upon said plurality of exercised promotion denominators, said targeted consumer being likely to exercise said particular promotion.

62. A system, comprising:
means for receiving a request for a provision of targeted promotions, said request including at least one parameter related to said provision of targeted promotions;
means for selecting likely exercisers of a targeted promotion from a plurality of consumers based at least in part upon promotions exercised by said likely exercisers;
means for determining a targeted promotion likely to be exercised by said likely exercisers based at least in part upon promotions exercised by said likely exercisers; and
means for providing information related to at least one of said selected likely exercisers and said determined targeted promotion,
wherein said at least one parameter related to said provision of targeted promotions is used in at least one of said selecting step and said determining step.

63. A system, comprising:
a consumer identification information receiver configured to receive particular consumer identification information;
a consumer identification record configured to contain stored consumer identification information;
an exercised promotion record configured to contain a record of promotions exercised by said particular consumer;
a promotion output device configured to output a targeted promotion selected at least in part based upon said record of promotions exercised by said particular consumer; and
a processor configured to use said received particular consumer identification information to identify a particular consumer using said stored consumer identification information, and moreover to select said targeted promotion at least in part based upon said record of promotions exercised by said particular consumer contained in said exercised promotion record.

64. The system according to claim 63, wherein:
said promotion output device comprises a network interface; and
said targeted promotion comprises an electronic signal.

65. The system according to claim 63, further comprising:
a consumer promotion usage denominator identifier configured to identify a promotion usage denominator for said particular consumer based at least in part upon said record of promotions exercised by said particular consumer contained in said exercised promotion record.

66. The system according to claim 65, wherein said promotion usage denominator comprises a promotion relative value denominator.

67. The system according to claim 65, wherein said promotion usage denominator comprises a promotion absolute value denominator.

68. The system according to claim 65, wherein said promotion usage denominator comprises a promotion delivery method denominator.

69. The system according to claim 65, wherein said promotion usage denominator comprises a promotion exercise location denominator.

70. The system according to claim 65, wherein said promotion usage denominator comprises a promotion promoted product denominator.

71. The system according to claim 65, wherein said promotion usage denominator comprises a promotion class denominator.

72. The system according to claim 65, wherein said promotion usage denominator comprises a promotion exercise frequency denominator.

73. The system according to claim 65, wherein:
said promotion usage denominator is based upon said record of promotions exercised in a first industry; and
said targeted promotion is for a second product in a second industry.

74. The system according to claim 73, wherein said first industry comprises a packaged goods industry.

75. The system according to claim 65, wherein:
said promotion usage denominator is based upon said record of promotions exercised in a first product class; and
said targeted promotion is for a second product in a second product class.

76. The system according to claim 74, wherein said first product class comprises goods and said second product class comprises services.

77. The system according to claim 65, wherein:
said promotion usage denominator is based upon said record of promotions exercised for a first product class; and
said targeted promotion is for a second product in a second product class.

78. The system according to claim 77, wherein said first product class comprises goods found at a supermarket.

79. A system, comprising:
a promotion identification information receiver configured to receive particular promotion identification information from a vendor, said particular promotion identification information relating to a particular promotion;
an exercised promotion record configured to store a plurality of promotion usage denominators for a plurality of consumers, said plurality of promotion usage denominators based at least in part on a record of promotions exercised by said plurality of consumers;
a likely promotion exercisers output device configured to output a plurality of likely promotion exercisers of said particular promotion selected from said plurality of consumers based at least in part upon said plurality of promotion usage denominators; and
a processor configured to use said received particular promotion identification information to select said plurality of likely promotion exercisers using said plurality of promotion usage denominators, and moreover to indicate to said likely promotion exercisers output device to output said plurality of likely promotion exercisers.

80. The system according to claim 79, wherein:
said likely promotion exercisers output device comprises a network interface; and
said output plurality of likely promotion exercisers comprises an electronic signal.

81. The system according to claim 79, wherein said plurality of promotion usage denominators comprise a plurality of promotion relative value denominators.

82. The system according to claim 79, wherein said plurality of promotion usage denominators comprise a plurality of promotion absolute value denominators.

83. The system according to claim 79, wherein said plurality of promotion usage denominators comprise a plurality of promotion delivery method denominators.

84. The system according to claim 79, wherein said plurality of promotion usage denominators comprise a plurality of promotion exercise location denominators.

85. The system according to claim 79, wherein said plurality of promotion usage denominators comprise a plurality of promotion promoted product denominators.

86. The system according to claim 79, wherein said plurality of promotion usage denominators comprise a plurality of promotion class denominators.

87. The system according to claim 79, wherein:
said plurality of promotion usage denominators are based upon said record of promotions exercised in a first industry; and
said particular promotion is for a second product in a second industry.

88. The system according to claim 87, wherein said first industry comprises a packaged goods industry.

89. The system according to claim 79, wherein:
said plurality of promotion usage denominators are based upon said record of promotions exercised in a first product class; and
said particular promotion is for a second product in a second product class.

90. The system according to claim 89, wherein said first product class comprises goods and said second product class comprises services.

91. The system according to claim 79, wherein:
said plurality of promotion usage denominators are based upon said record of promotions exercised for a first product class; and
said particular promotion is for a second product in a second product class.

92. The system according to claim 91, wherein said first product class comprises goods found at a supermarket.

93. A computer readable medium containing program instructions for execution on a computer system, which when executed by the computer system, cause the computer system to perform the method recited in any one of claims 1 to 59.
